(19) United States
(12) Patent Application Publication
(10) Pub. No.: US 2014/0249899 A1
(43) Pub. Date: Sep. 4, 2014

(54) SYSTEM AND METHOD OF APPLYING REWARDS TO FEES IN QUALIFYING ACCOUNTS OF FINANCIAL INSTITUTIONS

(71) Applicant: BANCVUE, LTD., Austin, TX (US)

(72) Inventors: Gabriel Michael Krajicek, Autin, TX (US); Gregory Michael Corlin, Austin, TX (US); Diane R. Christensen, Austin, TX (US)

(73) Assignee: BANCVUE, LTD., Austin, TX (US)

(21) Appl. No.: 13/782,999

(22) Filed: Mar. 1, 2013

(51) Int. Cl. G06Q 30/02

(52) U.S. Cl. CPC G06Q 30/0215
USPC 705/14.15; 705/14.17

(57) ABSTRACT

A system, computer program product and a method of applying rewards to fees in qualifying accounts of a financial institution are provided. The system, computer program product and method ensure that one or more reward accounts of a single account holder or “household” of account holders at the financial institution are qualified to receive a reward, are entitled to receive income other than the reward amount, that the account holder of the account is enrolled to receive one or more service for a service fees from the financial institution and that the fees are entitled to be automatically offset against income earned by the reward accounts during the predetermined cycle. If so, the system, computer program product and method deduct the fees from the sum of earned reward amount and the income other than the reward amount. In cases where the sum of the earned reward amount and the income from other than the reward amount is less than the service fee, a credit is automatically applied to the account holder that is up to or equal to the difference as a further reward to the account holder for having the reward account.

### CROSS-REFERENCE TO RELATED APPLICATIONS

The following co-pending and co-assigned application contains related information: U.S. patent application Ser. No. 12/171,289, entitled “PAYING ALTERNATE INTEREST RATES ON INTEREST BEARING ACCOUNTS,” by inventors Gabriel M. Krajicek et al., filed Jul. 10, 2008, and is hereby incorporated herein by reference.

The following co-pending and co-assigned application contains related information: U.S. patent application Ser. No. 11/828,097, entitled “METHOD, SYSTEM AND COMPUTER PROGRAM PRODUCT FOR CHARITABLE CHECKING,” by inventors Donald Gordon Shafer, et al., filed Jul. 25, 2007, and is hereby incorporated herein by reference.

The following co-pending and co-assigned application contains related information: U.S. patent application Ser. No. 12/572,252, entitled “PAYING A REWARD TO A SECOND ACCOUNT BASED UPON QUALIFICATIONS BEING MET BY A FIRST ACCOUNT,” by inventors Gabriel M. Krajicek et al.' filed Oct. 1, 2009, and is hereby incorporated herein by reference.

The following co-pending and co-assigned application contains related information: U.S. patent application Ser. No. 12/167,034 entitled “FINANCIAL INSTITUTION ACCOUNT-ASSOCIATED REWARDS PROGRAM,” by inventors Gabriel M. Krajicek et al. filed Jul. 2, 2008, and is hereby incorporated herein by reference.

### BACKGROUND OF THE INVENTION

1. Technical Field

The present invention relates generally to applying rewards to accounts at depository financial institutions and is specially directed to a system and method of granting additional rewards as incentives for account holders to enroll in value-added services that generate fees for the financial institutions.

2. Description of Related Art

Originally, financial institutions offered “reward” programs that allowed account holders to earn interest on an average balance during a given time period. More recently, some financial institutions have offered reward programs that have the rewards tied to: a) balances kept in depository accounts at the financial institutions; b) multiple accounts at the financial institutions; or c) points earned for each credit/debit card purchase or transaction amount whereby the points may be used to purchase merchandise from specific stores, catalogs or websites.

Further, some financial institutions have started to offer reward accounts that allow account holders to receive automatic credits for various fees that the account holders may have incurred. An account holder, however, may not be eligible to receive the rewards unless the account holder has certain reward accounts that meet certain qualification criteria such as requiring use of a debit card in order to refund ATM fees that their reward account holders may have incurred at “foreign” financial institutions' ATMs.

One more recent development has been the reward account—typically a demand deposit account, such as a checking account or other low/non-interest bearing account—that offered a “reward” interest rate to a reward account holder. This reward interest rate was higher, sometimes significantly higher, than the market average for a similar type of account. But, just as in the case of the automatic credits, account holders would only earn the higher interest rate if they qualified for it by meeting certain criteria.

Since the financial crisis that began in 2008, Congress has passed new laws that reduce the amount of income that financial institutions can generate from their traditional services. In the case of smaller financial institutions, such as community banks and credit unions, there is a need for non-interest income to make up for losses stemming from the referenced regulatory changes that adversely affect such financial institutions' ability to generate income.

Thus, there is a need for new value-added services at financial institutions, i.e., services that are ancillary to core services traditionally provided by such financial institutions. Core services generally include interest bearing deposit accounts such as checking and savings; loans; etc. while ancillary services include, but are not limited to, notary public services, identification (ID) fraud protection service, bill payment services, etc.

Fees charged for value-added services usually depend on whether the financial institution regards the services as amenities that are intended to create a stronger rapport with the account holders or as an additional revenue stream. For instance, notary public services, which usually entail notarizing legal papers for account holders, may be regarded as an amenity intended to create a stronger rapport between a community-based financial institution and its account holders; and thus may be provided as a complimentary service. By contrast, ID fraud protection may be regarded as an additional revenue stream and may thus be provided at a modest fee.

Current laws require that account holders at depository financial institutions be properly, promptly, accurately, and regularly informed of the status of their accounts, including earned amounts of interest on an interest-bearing account and estimated or actual annual percentage yield on the balances held in the account. Such laws also require that account holders be properly, promptly, accurately, and regularly informed of fees imposed on the accounts. To comply with such laws, most financial institutions provide a statement that includes at least all that the laws require to each account holder on a monthly or other periodic basis.

Thus, fees that a financial institution charges its account holders are usually presented to the account holders at end of this statement cycle. Interest accrued on interest bearing accounts, as well as ATM reimbursement fees or any other reimbursement fees, are likewise presented to the account holders at the end of the statement cycle.

At the end of a cycle, therefore, an account holder may have to pay fees that are incurred during the cycle as well as earn income (from interest bearing accounts and reimbursement fees). Since the account holder may receive income as well as pay fees at the end of a cycle, it would be desirable to have the fees be automatically deducted from the income earned during that cycle as a further value-added service to the account holders.

Some financial institutions (e.g., large banks) may maintain their own proprietary data processing systems that reconcile and manage accounts. Many smaller financial institutions (e.g., community banks and credit unions) do not have their own data processing systems for reconciling and managing accounts. Instead, these smaller financial institutions may rely on third-party “core processing” solutions to do so. A “core processor” refers to a processing system that specializes in account transactional reconciliation including but not limited to matching debit and credit transactions from activities such as cashing and writing checks, point-of-sale (POS) debits, and money transfers for an account holder at a financial institution. Thus, in addition to reconciling and managing accounts, a core processing system may also determine interests due on accounts, issuing end of cycle statements etc.

Regardless to whether a financial institution is using its own processing system or a third party's processing system, there is a need for regulatory-compliant “rewards” accounts that provide further rewards to qualifying accounts as a mechanism to promote value-added services to a financial institution's account holders. There is also a need for account holders to use their rewards to pay for value-added services from the financial institutions. There is a further need of reconciling financial institutions' account for providing the additional value-added services, as well as accounts of account holders at the financial institution who purchase value-added services and receive various rewards when they meet certain qualifying criteria.

### SUMMARY OF THE INVENTION

The present disclosure provides a system, computer program product and computer-implemented method of automatically applying rewards to a reward account of an account holder at a financial institution. The system, computer program product and computer-implemented method;
determine whether the reward account at the financial institution meets, for a predetermined cycle, all qualification criteria for receiving a first reward,
calculate a first reward amount earned by the reward account in response to determining that the reward account meets all qualification criteria for receiving the first reward for the predetermined cycle,
determine whether the reward account is entitled to receive income other than the first reward amount for the predetermined cycle,
add the first reward amount and the income other than first reward amount to a sum of earned income in response to determining that the reward account is entitled to receive income other than first reward during the predetermined cycle, determine whether the account holder is enrolled to receive at least one service for a service fee from the financial institution during the predetermined cycle,
determine, in response to determining that the account holder is enrolled to receive a service for a service fee from the financial institution during the predetermined cycle, whether the at least one service fee is entitled to be automatically offset against income earned by the reward account during the predetermined cycle,
determine whether the sum of earned income is greater than the service fee during the predetermined cycle, and either
   automatically deduct the service fee from the sum of earned income in response to determining that the sum of earned income is greater than the service fee during the predetermined cycle, and automatically apply the sum of earned income toward the service fee, or
   apply a reward credit amount to the reward account up to any difference between the service fee and the sum of earned income in response to determining that the sum of earned income is less than the service fee,
      thereby providing the account holder of the reward account an additional reward equal to the applied reward credit when the reward account meets the qualification criteria during the predetermined cycle.

In a particular embodiment, the system, computer program product and computer-implemented method issue an end of cycle statement to the account holder, the end of cycle statement including fees debited from and income credited to the reward account, wherein the income credited to the reward account includes the applied reward credit amount automatically credited to the account holder when the sum of earned income is less than the service fee.

In one aspect, the income other than the first reward includes automatic teller machine (ATM) fee refunds, a bill payment service fee refund, an account aggregation service fee refund, account service charge refund, and/or a mobile phone-enabled financial services fee refund. In another aspect, the service fee includes an identification fraud protection service fee, a bill payment services fee, an account aggregation service fee, and/or a mobile phone-enabled financial services fee.

The present disclosure also provides a system, computer program product and computer-implemented method of reconciling income in an account for a financial institution at an end of a cycle, the financial institution having reward accounts held by reward account holders. The system, computer program product and computer-implemented method
determine whether the reward account at the financial institution meets, for a predetermined cycle, all qualification criteria for receiving a first reward,
calculate any reward amount earned by the reward account in response to determining that the reward account meets all qualification criteria for receiving the first reward for the predetermined cycle,
determine whether the reward account is entitled to receive income other than the first reward amount for the predetermined cycle,
add the first reward amount and the income other than the first reward amount to a sum of earned income in response to determining that the reward account is entitled to receive income other than first reward amount during the predetermined cycle,
add this calculated sum of earned reward and other income to the sum of earned reward and other income of the reward account,
determine whether the account holder is enrolled to receive at least one service for a service fee from the financial institution during the predetermined cycle,
determine, in response to determining that the account holder is enrolled to receive a service for a service fee from the financial institution during the predetermined cycle, whether the one or more service fees are entitled to be automatically offset against income earned by the reward account during the predetermined cycle,
determine whether the sum of earned income is greater than the service fee during the predetermined cycle, and either
   automatically deduct the service fee from the sum of earned income in response to determining that the sum of earned income is greater than the service fee during the predetermined cycle, or
   apply a reward credit amount to the reward account up to any difference between the service fee and the sum of earned income in response to determining that the sum of earned income is less than the service fee,
      thereby providing the account holder of the reward account an additional reward when the reward account meets the qualification criteria during the predetermined cycle.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 illustrates an exemplary computer system within which various aspects of the disclosure can be implemented, according to one or more embodiments.

FIG. 2A depicts a flowchart of a process that may be used by a system for implementing the methods of the disclosure, including reconciling and managing customer accounts of a financial institution.

FIG. 2B is a flowchart of a process that may be used by the system for implementing a more specific embodiment of the methods of the disclosure, including reconciling and managing customer accounts of a financial institution.

FIG. 2C is a flowchart of a process that may be used by the system for implementing another more specific embodiment of the methods of the disclosure, including reconciling and managing customer accounts of a financial institution.

FIG. 2D is a flowchart of a process that may be used by the system for implementing a third more specific embodiment of the methods of the disclosure, including reconciling and managing customer accounts of a financial institution.

FIG. 3 is a flowchart of a process that may be used by the system for implementing the methods of the disclosure, including debiting and crediting accounts of a financial institution.

### DETAILED DESCRIPTION

In the following detailed description of exemplary embodiments of the disclosure, specific embodiments in which the disclosure may be practiced are described in sufficient detail to enable those skilled in the art to practice the disclosed embodiments. For example, specific details such as specific method orders, structures, elements, and connections are presented herein. However, it is to be understood that the specific details presented need not be utilized to practice the embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments,” or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

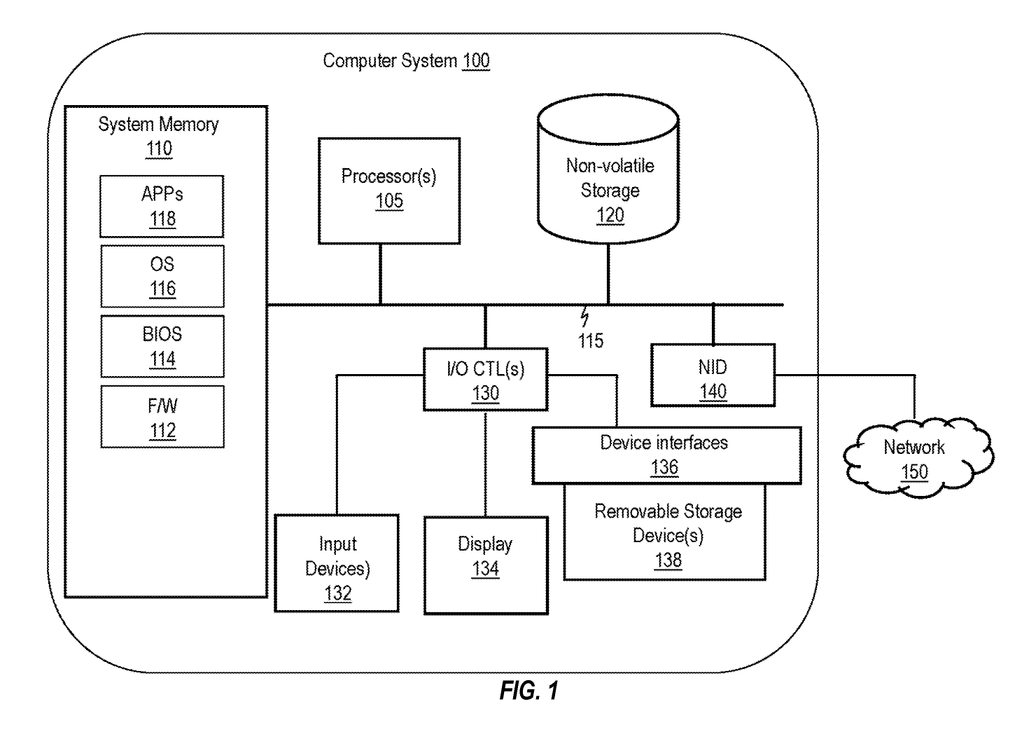

With reference now to the figures, wherein like reference numbers denote like parts, FIG. 1 illustrates a block diagram representation of an exemplary computer system 100, within which one or more of the described features of the various embodiments of the disclosure can be implemented. For purposes of this disclosure, the computer system 100 may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, the computer system 100 may be a handheld device, personal computer, a server, a network storage device, or any other suitable device and may vary in size, shape, performance, functionality, and price. The computer system 100 may include random access memory (RAM), one or more processing resources such as a central processing unit (CPU) or hardware or software control logic, ROM, and/or other types of nonvolatile memory. Additional components of the computer system 100 may include one or more disk drives, one or more network ports for communicating with external devices as well as various input and output (I/O) devices, such as a keyboard, a mouse, and a video display. The computer system 100 may also include one or more buses operable to transmit communications between the various hardware components.

Referring specifically to FIG. 1, exemplary computer system 100 includes one or more processor(s) 105 coupled to a system memory 110 via system interconnect 115. System interconnect 115 can be interchangeably referred to as a system bus in one or more embodiments. System memory 110 can include therein a plurality of software and/or firmware modules including firmware (F/W) 112, basic input/output system (BIOS) 114, operating system (O/S) 116, and application(s) 118. The one or more software and/or firmware modules within system memory 110 can be loaded into processor(s) 105 during operation of the computer system 100.

Computer system 100 further includes one or more input/output (I/O) controllers 130 which support connection by, and processing of signals from, one or more connected input device(s) 132, such as a keyboard, mouse, touch screen, or microphone. I/O controllers 130 also support connection to and forwarding of output signals to one or more connected output devices, such as a monitor or display device 134, a camera, a microphone, or audio speaker(s). Additionally, in one or more embodiments, one or more device interfaces 136, such as an optical reader, a universal serial bus (USB), a card reader, Personal Computer Memory Card International Association (PCMCIA) slot, and/or a high-definition multimedia interface (HDMI), can be associated with computer system 100. Device interface(s) 136 can be utilized to enable data to be read from or stored to corresponding removable storage device(s) 138, such as a compact disk (CD), digital video disk (DVD), flash drive, or flash memory card. Device interfaces 136 can further include General Purpose I/O interfaces such as I²C, SMBus, and peripheral component interconnect (PCI) buses.

Computer system 100 comprises a network interface device (NID) 140. NID 140 enables computer system 100 to communicate and/or interface with other devices, services, and components that are located externally to computer system 100. These devices, services, and components can interface with computer system 100 via an external network, such as exemplary network 150, using one or more communication protocols. Network 150 can be a local area network, wide area network, personal area network, and the like, and the connection to and/or between network and computer system 100 can be wired or wireless or a combination thereof. For purposes of discussion, network 150 is indicated as a single collective component for simplicity. However, it should be appreciated that network 150 can comprise one or more direct connections to other devices as well as a more complex set of interconnections as can exist within a wide area network, such as the Internet.

Those of ordinary skill in the art will appreciate that the hardware components and basic configuration depicted in FIG. 1 and described herein may vary. For example, the illustrative components within computer system 100 are not intended to be exhaustive, but rather are representative to highlight components that can be utilized to implement different aspects of the present disclosure. For example, other devices/components may be used in addition to or in place of the hardware depicted. The depicted example does not convey or imply any architectural or other limitations with respect to the presently described embodiments and/or the general disclosure.

According to an embodiment of the invention, account holders that enroll in value-added services for which there are service fees may have the one or more of such fees covered by rewards received from one or more “reward” accounts, such as, for example, the reward accounts described in the above-identified related co-pending patent applications. More specifically, the above-referenced reward accounts may provide one or more of the following type of rewards: 1) a “reward interest” account wherein the account holder earns a higher than market rate reward interest rate if the account meets certain specified qualifying criteria during a predetermined cycle; 2) a “charitable checking” wherein the financial institution matches an account holder's charitable contribution to a charity out of the reward interest income received by the account holder when the account meets certain specified qualifying criteria during a predetermined cycle; 3) an above market “reward interest rate” in a second account at a financial institution based upon a first account meeting certain qualifying criteria during a predetermined cycle. The first reward may also be 1) a cash rebate based on the number and/or type of purchases made by the account holder using a payment card associated with the reward account or 2) a merchant funded reward wherein the reward may be applied to another purchase at the merchant.

For example, account holders who enroll to receive an ancillary value-added bank product or service such as, for example, ID fraud protection services, bill payment services, or account aggregation services, mobile phone-enabled financial transactions (“digital wallet”), or preferred member services, and have a “reward” account that qualifies to receive a reward by it or another account meeting the required qualification criteria during a predetermined cycle, such as, for example, the statement cycle, will be entitled to have the “rewards” applied toward the service fee for the ancillary product or service. Similarly, if an account holder or a related group of account holders, such as a household, has two or more “reward” accounts that all qualify to receive a reward by meeting their respective required qualification criteria during a predetermined cycle, and may even have two or more ancillary bank products for which there are service fees, the “reward” account rewards may be combined and applied toward the sum of the ancillary product or service fees, which are hereinafter referred to collectively as “service fees”.

In a particular embodiment, the account reward to be applied toward a particular value added service (such as an ID fraud protection service fee, online bill payment services fee, account aggregation services fee, mobile-phone enabled financial services fee, etc.) may include a first reward, such as interest income based upon a reward interest rate plus refunds of ATM fees charged to the account as a result of the account holder having used a “foreign” ATM machine of an unaffiliated financial institution. If the sum of the first reward is lower than the service fee(s) for the one or more value-added services in which the account holder enrolls, a credit may be automatically issued to the account holder as an additional reward such that the account holder never need more than the amount for their first reward to pay for the value-added services for which they are enrolled.

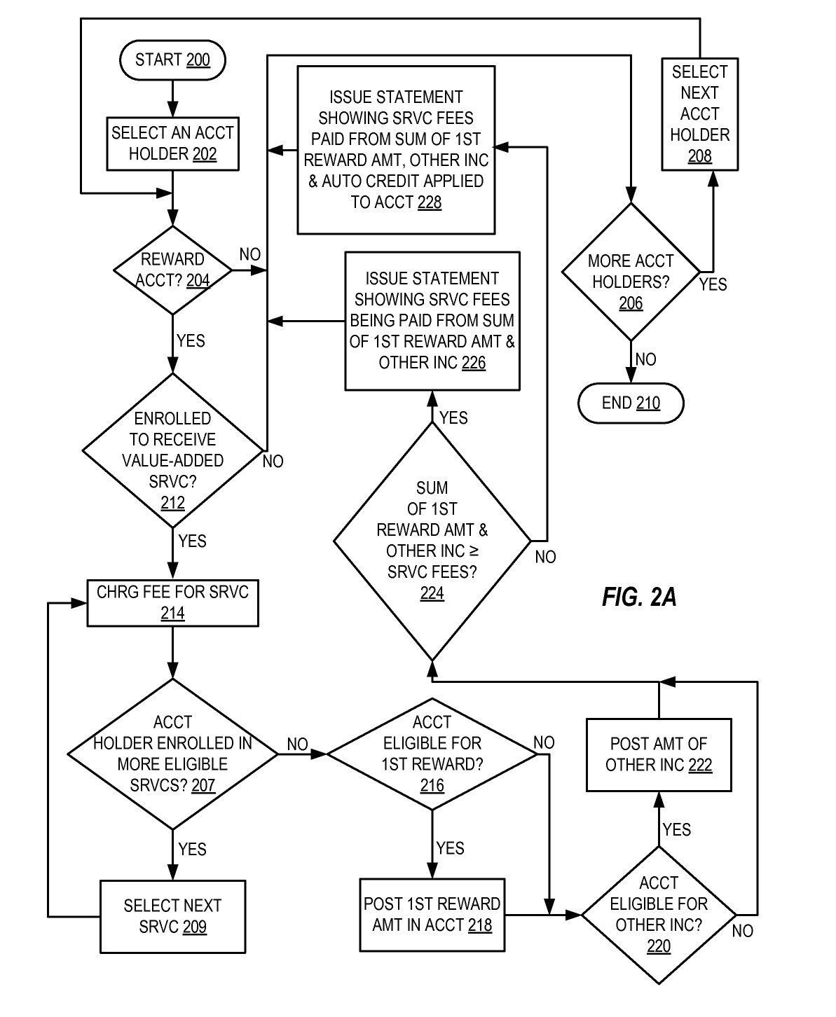

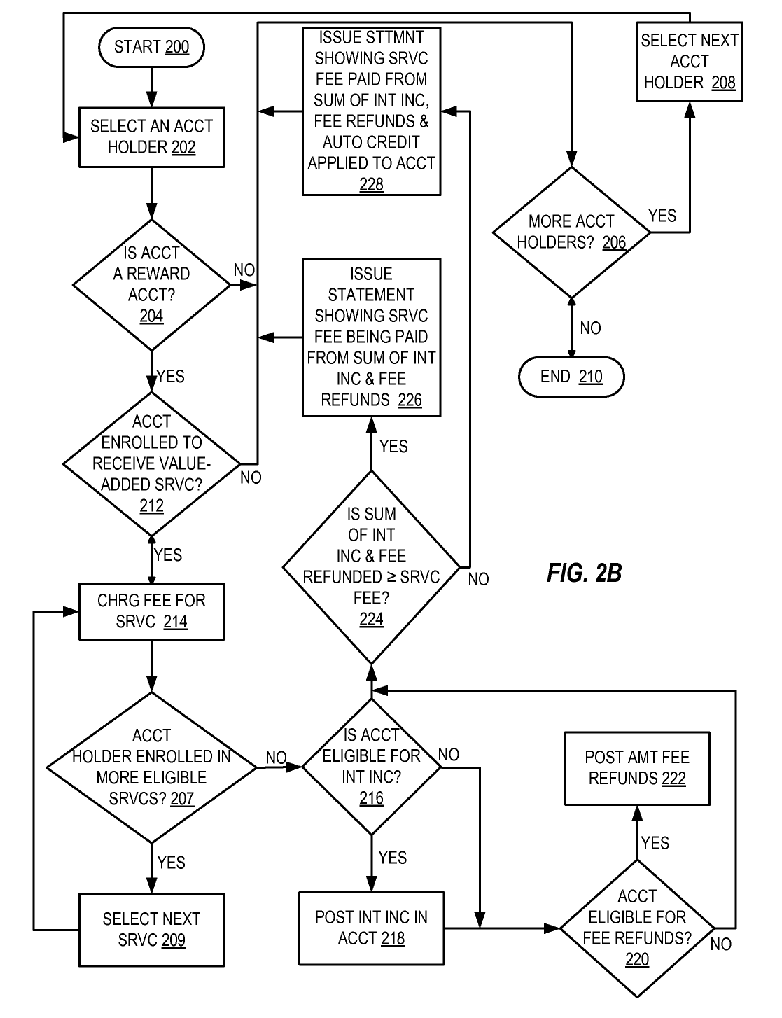

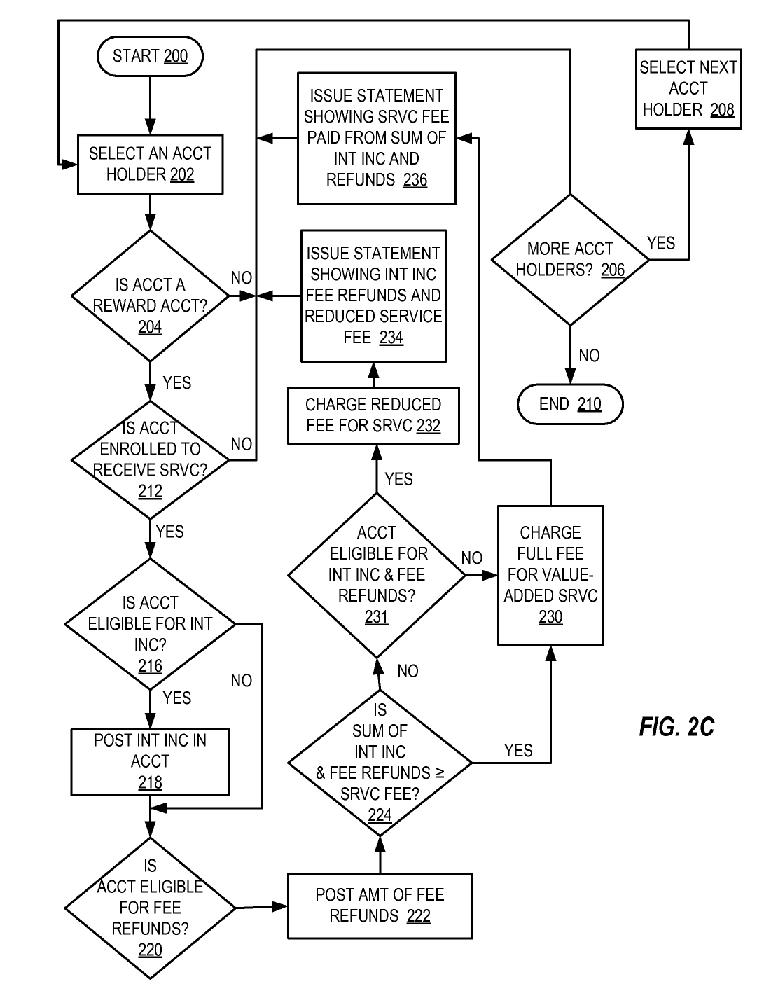

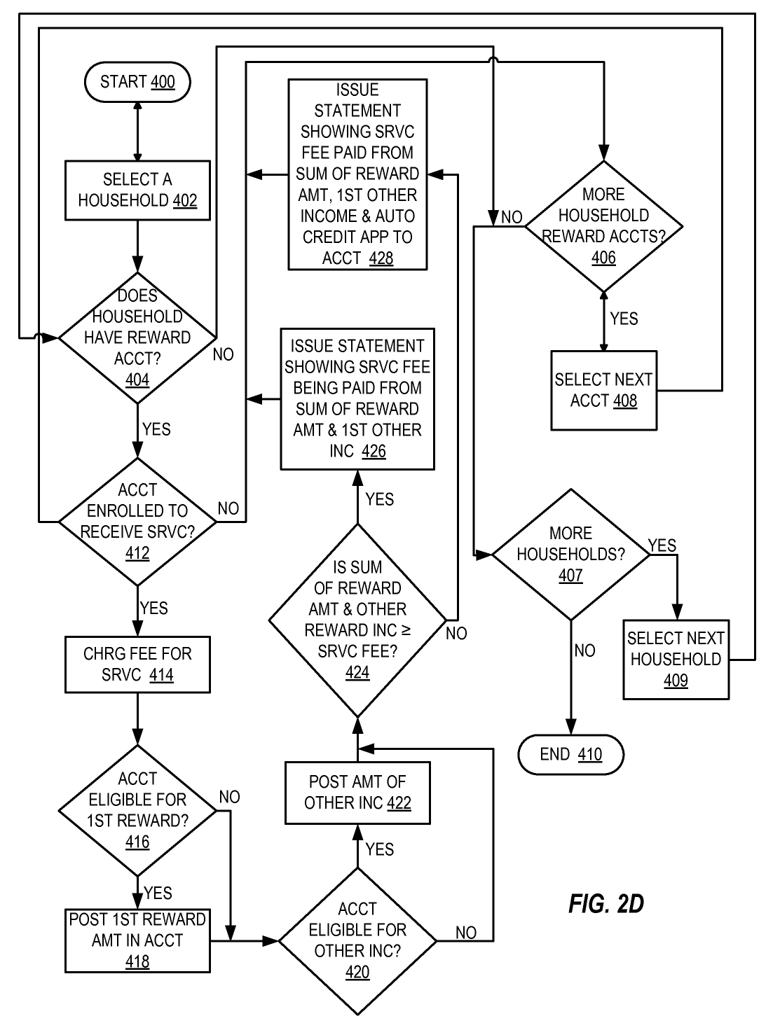

FIG. 2A depicts a flowchart of a process that may be used by the system for carrying out the steps of the process and for reconciling and managing reward accounts at a financial institution. The process starts at the end of each cycle (block 200). Upon starting, the system selects an account holder (block 202). The account holder may be selected on an alphabetic basis or based on account numbers or based on any other criterion so long as all the account holders get to be selected in an orderly fashion. Once an account holder is selected, the system may determine whether the account of the account holder is a reward account (block 204). If the account is not a reward account, the system may determine whether there are any other account holders that have not yet been selected (block 206). If all the accounts have been selected, then the process ends (block 210). Otherwise, the system selects the next account holder (block 208) and jumps back to block 204 where the system determines whether the account of the account holder is a reward account.

If the account is a reward account, then another check is made to determine whether the account holder is enrolled in a value-added service for which there is a service fee (block 212). If not, the process jumps back to block 206 where the system determines whether there are any other account holders that have not yet been selected. If yes, the system will charge the reward account the service fee for the value-added service by subtracting the fee from the reward account of the account holder (block 214). The system next checks to see if the account holder is enrolled in more eligible value-added services (bock 207). If yes, the system selects the next service account (block 209) and the system will charge the reward account the service fee for the additional services, respectively (block 214).

Then the system will determine whether the account holder is eligible to receive a first reward from the reward account during the cycle. As noted earlier, the reward may be a higher than market average interest rate for the account or a related account, a cash-back amount based upon qualifying purchases made during the predetermined cycle, a merchant-funded reward for using the account to purchase products from the merchant, and/or special perks such as special fee reimbursement. Thus, at block 216, the system may determine whether the account holder is eligible to receive the first reward from the reward account. If so, the system will post first reward amount into the reward account of the reward account holder (block 218). If not, the system will jump to block 220. At block 220, the system will determine whether the account holder is eligible for other income, such as fee refunds. If so, the system will post the other income amount into the reward account of the account holder (block 222). If not, the system will jump to block 224. At block 224, the system will determine whether the sum of the first reward and the other income is greater or equal to the service fee of the value-added service. If so, the system will issue an end cycle statement to the reward account holder showing that the service fee for the value-added service is paid from the first reward amount and the other income earned (block 226).

The system then jumps back to block 206 where the system determines whether there are any other account holders that have not yet been selected. If the sum of the first reward amount and the other income is less than the service fee of the value-added service, then the system will issue an end cycle statement to the account holder showing that the service fee of the value-added service is paid out of the first reward amount earned, the other income earned and a credit amount that is automatically applied to the reward account holder (block 228). Then, the system again jumps back to block 206 where the system determines whether there are any other account holders that have not yet been selected.

FIG. 2B depicts a specific alternative embodiment in which the first reward is reward interest income and the other income are fee refunds, such as ATM fee refunds charged by foreign financial institutions to the particular account. Specific steps depicted in FIG. 2B that correspond to like steps in FIG. 2A have been given the same number.

For example, suppose account holders A, B, and C are each enrolled in a particular value-added service, such as ID fraud protection, for which they each have to pay a fee of ten dollars ($10.00). Suppose, further, that all three account holders have a reward account which receives a reward if the reward account meets predetermined qualifying criteria for receiving the reward during the predetermined cycle, such as a statement cycle. The reward may be interest income based upon a reward interest rate and a special perk (i.e., automatic credit for differences between earned rewards and certain service fees such as ID fraud protection fees), and that to receive the reward during the cycle, a certain number of transactions must have transpired in that cycle. Then every month, the financial institution will: (1) charge all three account holders the ten dollars for the ID fraud protection service, (2) post the reward interest income earned in the reward account of each account holder whose reward account qualifies for the reward interest, and (3) refund any ATM fees that each account holder may have incurred during the cycle, provided that the account holder is entitled to receive the refund fee.

The financial institution will then issue a statement to each reward account holder delineating the service fee incurred for the ID fraud protection service, the reward interest income earned by each reward account holder and any ATM fees that may be refunded to each reward account holder at the end of the statement cycle. Specifically, the service fee for the ID fraud protection will be deducted from the reward account of each account holder. Then, the income earned from the reward interest by each account holder will be added to the balance in the reward account of each account holder. The ATM fee refunded to each account holder will also be added to the balance in the reward account of each account holder. The statement issued to each reward account holder at the end of the statement cycle will include information that will show how the service fee for the ID fraud protection service is paid by each reward account holder (e.g., interest income earned+ATM fee refunds=ID fraud protection fee). If the sum of the interest income earned and ATM fees refund is more than the ID fraud protection fee, then the difference will be shown as going into the balance of the reward account. If the sum of the interest income earned and ATM fee refunds is less than the ID fraud protection, then a credit amount that is equal to the difference between the sum and the ID fraud protection fee will be shown as being given to the reward account holder (e.g., interest income earned+ATM fee refund+credit=fee), thereby providing the reward account with a special perk, an additional reward, as an incentive for enrolling in the value-added service.

Thus if in a particular month, the reward interest income earned is one dollar ($1.00) and the ATM fee refund is also one dollar ($1.00) for reward account holder A. And in that month, reward interest income earned is ten dollars ($10.00) and ATM fee refund is three dollars ($3.00) for reward account holder B, while both reward interest income earned and ATM fee refund are zero for reward account holder C. That is, reward account holder C did not make the appropriate number of transactions required to be eligible for the reward during the qualification cycle, and therefore, does not receive a reward for the cycle. Note that although reward account holder C does not qualify to receive the reward in the cycle, reward account holder C is still eligible to receive fifty cents ($0.50) based on a regulatory required non-qualifying interest rate. The statement issued to account holder A will include the following: $1.00 (interest income)+$1.00 (ATM fee refund)+$8.00 (credit)=$10.00 (ID fraud protection fee). The statement to reward account holder B will include the following: $10.00 (interest income)+$3.00 (ATM fee refund)=$10.00 (ID fraud protection fee)+$3.00 (additional reward credit applied toward the ID fraud protection fee). Since reward account holder C did not qualify for the rewards, the statement will only include the $10.00 fee taken from the balance of the reward account and the fifty cents ($0.50) interest earned added to the balance.

Financial institutions may use their own processing system, such as computer system 100, or a third party's computer processing system to implement the steps of the method of the present invention. As noted earlier, some financial institutions may run their own proprietary core processor system to reconcile and manage accounts for all of the account holders of the financial institution. Alternatively, some other financial institutions, such as credit unions and community banks, may use third party core processor systems to do so. Note that applications 118 (see FIG. 1), which carry out the steps of the processes to implement the present invention and traditional applications, which may carry out traditional steps to reconcile and manage all of the financial institutions account may reside within the same computer system. Alternatively, applications 118 to carry out the present invention may reside in computer system 100, which in turn, is in electronic communications with a separate core processor system through the network 150, which may include the Internet. If the financial institution where account holders A, B and C hold an account uses a separate core processor system, the system of the present invention will include the computer system 100 linked to the separate core processor system for reconciling and managing the accounts of account holders A, B and C for the financial institution.

In any case, every month the system will assess the reward accounts of account holders A, B and C the ten dollar fee for the ID fraud protection by deducting the fee from their accounts. The system will post any interest earned and refunded fees to the reward account of each reward account holder for which the reward account holder is eligible. The system will also issue end of cycle statements to reward account holders A, B and C.

The system will then credit the account it manages for the financial institution the fees deducted from account holders A, B and C. The system may debit reward amounts given to account holders from the account it manages for the financial institution. The system will also issue end of cycle statements for the financial institution showing all funds debited from and credited to the applicable reward account of the financial institution account holders.

In one example, the actual ID protection may be a proprietary fraud protection product marketed by BancVue, the assignee of this application, or it may be a product provided by a third party company, such as CSIdentity Corporation (CSID) of Austin, Tex. USA. Such fraud detection companies provide identity fraud protection and theft detection products and services for individuals, government agencies, and businesses. Such third party companies may charge the financial institution a fee for each account holder for which the ID fraud protection is provided.

At the end of each cycle, the system will account for all charges assessed, credits given etc. to the financial institution. To continue with the example above, at the end of each cycle, the system will post in the account of the financial institution the ten dollars assessed from each of the accounts of account holders A, B and C. Thus, thirty dollars ($30.00) will be added into the account of the financial institution. Since, an eight dollar ($8.00) credit is given to account holder A, the system will deduct eight dollars from the amount posted in the account of the financial institution ($30.00−$8.00=$22.00). If the financial institution is to pay a service fee of one dollar and fifty cents ($1.50) per account holder for the fraud detection service, then the system may deduct four dollars and fifty cents ($4.50) from the amount posted in the account of the financial institution ($22.00−$4.50=$17.50). FIG. 2B depicts a flowchart of a process that may be used by the system for carrying out the steps of the process and for reconciling and managing reward accounts at a financial institution. The process starts at the end of each cycle (block 200). Upon starting, the system selects an account holder (block 202). The account holder may be selected on an alphabetic basis or based on account numbers or based on any other criterion so long as all the account holders get to be selected in an orderly fashion. Once an account holder is selected, the system may determine whether the account of the account holder is a reward account (block 204). If the account is not a reward account, the system may determine whether there are any other account holders that have not yet been selected (block 206). If all the accounts have been selected, then the process ends (block 210). Otherwise, the system selects the next account holder (block 208) and jumps back to block 204 where the system determines whether the account of the account holder is a reward account.

If the account is a reward account, then another check is made to determine whether the account holder is enrolled in a value-added service for which there is a fee (block 212). If not, the process jumps back to block 206 where the system determines whether there are any other account holders that have not yet been selected. If yes, the system will charge the account the fee by subtracting the fee from the reward account of the account holder (block 214). Then the system will determine whether the account holder is eligible to receive a reward from the reward account during the cycle. As noted earlier, the reward may be a higher than market average interest rate and/or special perks such as special fee reimbursement. Thus, at block 216, the system may determine whether the account holder is eligible to receive interest income from the reward account. If so, the system will post the interest income into the reward account of the reward account holder (block 218). If not, the system will jump to block 220. At block 220, the system will determine whether the account holder is eligible for a special fee refund. If so, the system will post the refund fee into the reward account of the account holder (block 222). If not, the system will jump to block 224. At block 224, the system will determine whether the sum of the interest income earned and the refund fee is greater or equal to the fee of the value-added service. If so, the system will issue an end cycle statement to the reward account holder showing that the fee for the value-added service is paid from the interest income earned and the fee refunded (block 226). The system then jumps back to block 206 where the system determines whether there are any other account holders that have not yet been selected. If the sum of the interest income earned and the refund fee is less than the fee of the value-added service, then the system will issue an end cycle statement to the account holder showing that the fee of the value-added service is paid out of the interest income earned, the fee refunded and a credit amount that is automatically applied to the reward account holder (block 228). Then, the system again jumps back to block 206 where the system determines whether there are any other account holders that have not yet been selected.

FIG. 2C depicts another alternate embodiment wherein the additional reward is a reduced service fee for the enrolled services if the reward account meets the qualifying criteria. Except for the deletion of block 214, in FIG. 2C steps or blocks 200 through 222 correspond to like steps or blocks in FIG. 2B. Next, the system determines if the sum of the reward interest income (first reward) and any fee refunds is greater than or equal to the full amount of the charged service fee(s) (block 224). If yes, the system charges the account holder for the full service fee(s) for the value-added services(s) (block 230), and then the system issues a statement at the end of the cycle that shows the service fee paid from the sum of the reward interest amount and the fee refunds (block 236). If no, the system checks to see if the account is eligible for reward interest and fee refunds in block 231. If no, the system charges the full fee for the value-added service in block 230. If yes, the system only charges the account holder a reduced service fee, wherein the reward interest amount and the fee refunds are sufficient to pay for the reduced service fee (block 232). Then the system issues a statement that shows that the reward interest amount and fee refunds and the offsetting reduce service fee (block 234).

Using steps corresponding to the steps of FIG. 2C, wherein the reward credit has a maximum amount earned than can be applied toward the service fees.

FIG. 2D depicts another alternate embodiment in which the accounts of related account holders in a “household” are grouped together for the purposes of applying the rewards in the group of household accounts to group of various service fees charged for the group of value-added services provided to all of the household accounts. Steps or blocks 400 through 428 correspond to like steps or blocks 200 through 428 in FIG. 2A except blocks 202 and 204 of FIG. 2A are modified so that rather than selecting an account holder in 202, the system selects a household account in 402 and inquires in 404 whether the household has a reward account. In addition, two additional steps or blocks 407 and 409 are added so that the system first selects each of the reward accounts for all of the account holders in the household before proceeding to the next household of account holders.

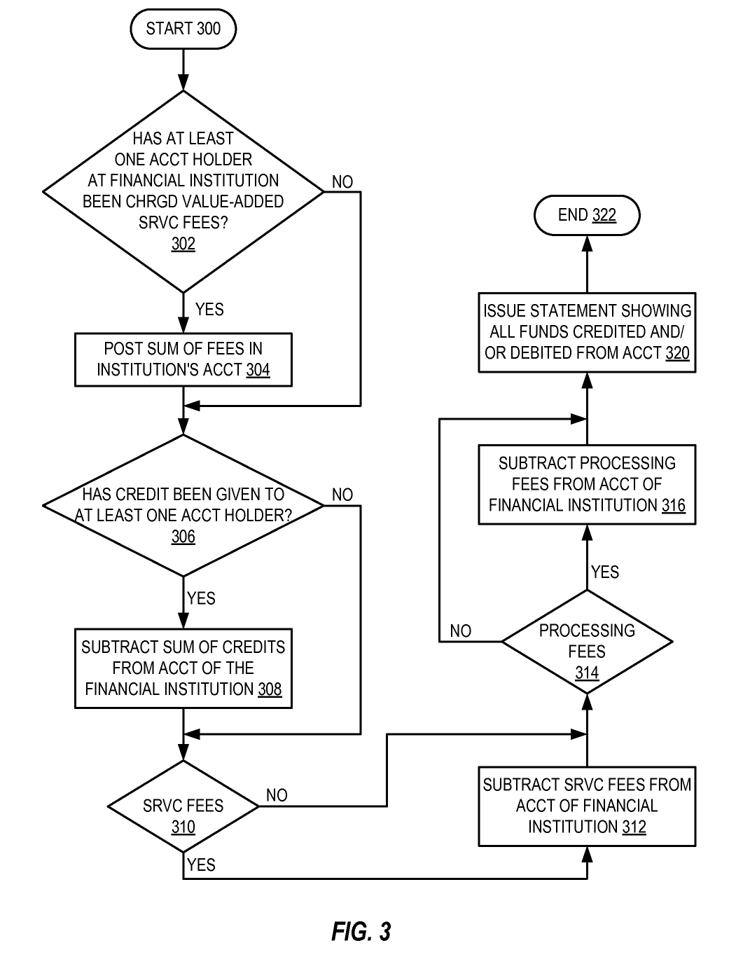

FIG. 3 is a flowchart of a process that may be used by the system for debiting and crediting a financial institution's account. The process starts at the end of each statement cycle (block 300). Upon starting, the system will determine whether at least one reward account holder at the financial institution is to be assessed at least one value-added service fee by the financial institution (block 302). If not, the system will jump to block 306. If at least one reward account holder is to be assessed a value-added service fee, the core processor will deduct the service fee from the account of the reward account holder. Fees from all reward account holders will be added and the sum will be posted into the account of the financial institution (block 304). At block 306, the system will determine whether credits have been given to at least one reward account holder of the financial institution. If not, the system will jump to block 310. If a credit has been given to at least one account holder, the system will subtract the credit (or credits if more than one account holder has been given a credit) from the account of the financial institution (block 308). At block 310, the system will determine whether there are service fees for value-added products or services. If not, the process jumps to block 314. If so, the value-added service fees are subtracted from the account of the financial institution (block 312). In the event there is an applications service provider (i.e. software as a service provider) providing the services to carry out the methods, at block 314, the system will also determine whether there are any processing fees being charged by such applications service provider for its services and whether it is charged to the financial institution or to the account holders. If not, the process jumps to block 320. If yes, the system will subtract the processing fees of the application service provider from the account of the financial institution (block 316). At block 320, the system will issue a statement to the financial institution showing all funds credited and/or debited from the account (block 320) and the process ends at block 316.

The invention may be in the form of a computer program product accessible from a computer-usable or computer-readable medium providing program code for use by or in connection with a computer or any other instruction execution system. For the purposes of this description, a computer-usable or computer readable medium can be any tangible apparatus that can contain, store, communicate, propagate, or transport the program for use by or in connection with the instruction execution system or device.

The medium can be an electronic, magnetic, optical, electromagnetic, infrared, or semiconductor system or device or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) Digital Video/Versatile Disk (DVD) etc.

The description of the present disclosure has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer-implemented method of automatically applying rewards to a reward account of an account holder at a financial institution, comprising:
determining whether the reward account at the financial institution meets, for a predetermined cycle, all qualification criteria for receiving a first reward;
calculating a first reward amount earned by the reward account in response to determining that the reward account meets all qualification criteria for receiving the first reward for the predetermined cycle;
determining whether the reward account is entitled to receive income other than the first reward amount for the predetermined cycle;
adding the first reward amount and the income other than the first reward amount to a sum of earned income in response to determining that the reward account is entitled to receive income other than the first reward amount during the predetermined cycle;
determining whether the account holder is enrolled to receive a at least one service for an at least one service fee from the financial institution during the predetermined cycle;
determining, in response to determining that the account holder is enrolled to receive the at least one service for the at least one service fee from the financial institution, whether the at least one service fee is entitled to be automatically offset against income earned by the reward account during the predetermined cycle;
determining whether the sum of earned income is greater than the at least one service fee;
automatically deducting the at least one service fee from the sum of earned income in response to determining that the sum of earned income is greater than the at least one service fee during the predetermined cycle; and
automatically applying the sum of earned income toward the at least one service fee and applying a credit amount to the reward account for any difference between the at least one service fee and the sum of earned income in response to determining that the sum of earned income is less than the at least one service fee, thereby providing the account holder of the reward account an additional reward equal to the applied credit amount when the reward account meets the qualification criteria during the predetermined cycle.

2. The computer-implemented method of claim 1, further including issuing an end of cycle statement to the account holder, the end of cycle statement including income debited from and credited to the reward account, wherein the income credited to the reward account includes the credit automatically applied to the account holder when the sum of earned income is less than the at least one service fee.

3. The computer-implemented method of claim 2, wherein the first reward amount is an interest income based on a “reward” interest rate.

4. The computer-implemented method of claim 2, wherein the first reward amount is a “cash back” amount based on purchases made through the reward account during the predetermined cycle.

5. The computer-implemented method of claim 2, wherein the first reward amount is a merchant funded reward.

6. The computer-implemented method of claim 2, wherein the income other than the first reward amount includes automatic teller machine (ATM) fee refunds.

7. The computer-implemented method of claim 2, wherein the income other than the first reward amount includes a bill payment service fee refund.

8. The computer-implemented method of claim 2, wherein the income other than the first reward amount includes a reward account service charge refund.

9. The computer-implemented method of claim 2, wherein the at least one service fee includes an identification fraud protection service fee.

10. The computer-implemented method of claim 1, wherein the at least one service fee includes membership fees.

11. The computer-implemented method of claim 1, wherein the at least one service fee includes a mobile phone-enable financial services fee.

12. The computer-implemented method of claim 1, wherein the at least one service fee includes an insurance premium.

13. The computer-implemented method of claim 1, wherein there are a plurality of reward accounts owned by one account holder or by one or more account holders in a household and wherein the first reward is the sum of the rewards associated with the plurality of reward accounts.

14. The computer-implemented method of claim 1, wherein there are a plurality of eligible services and the service fee is the sum of the service fees for the plurality of services.

15. The computer-implemented method of claim 1, wherein the additional reward credit has a maximum amount that may be applied toward the service fees.

16. The computer-implemented method of claim 1, wherein the additional reward credit is a reduced service fee rather than an additional reward credit amount.

17. A system for automatically applying rewards to a reward account of an account holder at a financial institution, the computer system comprising:
at least one storage device for storing code data; and
at least one processor for processing the code data to:
determine whether the reward account at the financial institution meets, for a predetermined cycle, all qualification criteria for receiving a first reward;
calculate a first reward amount earned by the reward account in response to determining that the reward account meets all qualification criteria for receiving the first reward for the predetermined cycle;
determine whether the reward account is entitled to receive income other than the first reward amount for the predetermined cycle;
add the first reward amount and the income other than the first reward amount to a sum of earned income in response to determining that the reward account is entitled to receive income other than the first reward amount during the predetermined cycle;
determine whether the account holder is enrolled to receive at least one service for an at least one service fee from the financial institution during the predetermined cycle;
determine, in response to determining whether the account holder is enrolled to receive the at least one service for the at least one service fee from the financial institution during the predetermined cycle, whether the at least one service fee is entitled to be automatically offset against the sum of earned income of the reward account during the predetermined cycle;
determine whether the sum of earned income is greater than the at least one service fee;
automatically deduct the at least one service fee from the sum of earned income in response to determining that the sum of earned income is greater than the service fee during the predetermined cycle; and
automatically apply the sum of earned income toward the at least one service fee and apply a reward credit amount to the reward account for any difference between the service fee and the sum of earned income in response to determining that the sum of earned income is less than the service fee, thereby providing the account holder of the reward account an additional reward equal to the applied reward credit amount when the reward account meets the qualification criteria during the predetermined cycle.

18. The system of claim 17 wherein the code data is further processed to include issuing an end of cycle statement to the account holder, the end of cycle statement including income debited from and credited to the reward account, wherein the earned income credited to the reward account includes the reward credit amount automatically applied to the account holder when the sum of earned income is less than the at least one service fee.

19. The system of claim 18, wherein the first reward is a reward interest rate and the first reward amount is an interest income based on the reward interest rate.

20. The system of claim 18, wherein the first reward amount is a “cash back” amount based on previous purchases made through the reward account during the predetermined cycle.

21. The system of claim 18, wherein the first reward amount is a merchant funded reward.

22. The system of claim 18, wherein the income other than the first reward amount includes automatic teller machine (ATM) fee refunds.

23. The system of claim 18, wherein the income other than the first reward amount includes a bill payment service fee refund.

24. The system of claim 18, wherein the income other than the first reward amount includes an account service charge refund.

25. The system of claim 18, wherein the at least one service fee includes an identification fraud protection service fee.

26. The system of claim 18, wherein the at least one service fee includes membership fees.

27. The system of claim 18, wherein the at least one service fee includes mobile phone-enabled financial services fees.

28. The system of claim 18, wherein the at least one service fee includes insurance premiums.

29. The system of claim 18, wherein the reward account can be the sum of multiple reward accounts owned by the same account holder or household.

30. The system of claim 18, wherein there is a plurality of eligible services and the at least one service fee comprises the sum of the service fees for the plurality of services.

31. The system of claim 17, wherein the additional reward credit has a maximum amount that may be applied toward the service fees.

32. The system of claim 17, wherein the reward credit is a deduction of the service fee rather than a credited reward amount.

33. A computer program code embodied in a computer-readable device for automatically applying rewards to a reward account of an account holder at a financial institution, the computer program code comprising processor executable instructions for:
determining whether the reward account at the financial institution meets, for a predetermined cycle, all qualification criteria for receiving a first reward;
calculating a first reward amount earned by the reward account in response to determining that the reward account meets all qualification criteria for receiving the first reward for the predetermined cycle;
determining whether the reward account is entitled to receive income other than the first reward for the predetermined cycle;
adding the first reward amount and the income other than the first reward amount to a sum of earned income in response to determining that the reward account is entitled to receive income other than the first reward amount during the predetermined cycle;
determining whether the account holder is enrolled to receive a at least one service for an at least one service fee from the financial institution during the predetermined cycle;
determining, in response to determining that the account holder is enrolled to receive the at least one service for the at least one service fee from the financial institution during the predetermined cycle, whether the at least one service fee is entitled to be automatically offset against income earned by the reward account during the predetermined cycle;
determining whether the sum of earned income is greater than the at least one service fee;
automatically deducting the at least one service fee from the sum of earned income in response to determining that the sum of earned income is greater than the at least one service fee during the predetermined cycle; and
automatically applying the sum of earned income toward the at least one service fee and applying a reward credit to the reward account for any difference between the at least one service fee and the sum of earned income in response to determining that the sum of earned income is less than the at least one service fee, thereby providing the account holder of the reward account an additional reward equal to the applied credit amount when the reward account meets the qualification criteria during the predetermined cycle.

34. The computer program code of claim 33, further including processor executable instructions for issuing an end of cycle statement to the account holder, the end of cycle statement including income debited from and credited to the reward account, wherein the income credited to the reward account includes the credit automatically extended to the account holder when the sum of earned income is less than the service fee.

35. The computer program code of claim 34, wherein the first reward is a reward interest rate and the first reward amount is an interest income based on the reward interest rate.

36. The computer program code of claim 34, wherein the reward amount is a “cash back” amount based on purchases made through the reward account during the predetermined cycle.

37. The computer program code of claim 34, wherein the reward amount is a merchant funded reward.

38. The computer program code of claim 34, wherein the income other than the first reward amount includes automatic teller machine (ATM) fee refunds.

39. The computer program code of claim 34, wherein the income other than the reward amount includes a bill payment service fee refund.

40. The computer program code of claim 34, wherein the income other than the first reward amount includes an account service charge refund.

41. The computer program code of claim 33, wherein the at least one service fee includes an identification fraud protection service fee.

42. The computer program code of claim 33, wherein the at least one service fee includes a preferred membership fee.

43. The computer program code of claim 33, wherein the at least one service fee includes mobile phone-enabled financial services fees.

44. The computer program code of claim 33, wherein the at least one service fee includes insurance premiums.

45. The computer program code of claim 33, wherein there are a plurality of reward accounts by the same account holder or a household and the first reward is the sum of the rewards of the plurality of reward accounts.

46. The computer program code of claim 34, wherein there are a plurality of eligible services and the “service fee” is the sum of the service fees for the plurality of services.

47. The computer program code of claim 34, wherein the reward credit has a maximum amount that can be applied toward the service fees.

48. The computer program code of claim 34, wherein the additional reward credit is a reduced service fee rather than a credited reward amount.

49. A computer-implemented method of reconciling income in an account for a financial institution at an end of a statement cycle, the financial institution having reward accounts held by reward account holders, the computer-implemented method comprising:
determining whether at least one reward account at the financial institution meets, for a predetermined cycle, all qualification criteria for receiving a first reward;
calculating a first reward amount earned by the at least one reward account in response to determining that the at least one reward account meets all qualification criteria for receiving the first reward for the predetermined cycle;
determining whether the at least one reward account is entitled to receive income other than the first reward amount for the predetermined cycle;
adding the first reward amount and the income other than the first reward amount to a sum of earned income in response to determining that the at least one reward account is entitled to receive income other than the first reward amount during the predetermined cycle;
determining whether the account holder of the at least one reward account is enrolled to receive a at least one service for an at least one service fee from the financial institution during the predetermined cycle;
determining, in response to determining that the account holder of the at least one reward account is enrolled to receive the at least one service for the at least one service fee from the financial institution during the predetermined cycle, whether the at least one service fee is entitled to be automatically offset against income earned by the at least one reward account during the predetermined cycle;
debiting the at least one service fee from the at least one reward account, in response to determining that the account holder of the at least one reward account is enrolled to receive the at least one service for the at least one service fee from the financial institution during the predetermined cycle;
crediting the at least one service fee debited from the at least one reward account to the account for the financial institution;
determining whether the sum of earned income is greater than the at least one service fee;
automatically deducting the at least one service fee from the sum of earned income in response to determining that the sum of earned income is greater than the at least one service fee during the predetermined cycle;
automatically applying the sum of earned income toward the at least one service fee and applying a reward credit amount to the at least one reward account for any difference between the service fee and the sum of earned income in response to determining that the sum of earned income is less than the service fee;
debiting the credit amount automatically applied to the at least one reward account from the account for the financial institution; and
issuing an end of cycle statement to the financial institution, the end of cycle statement including all sums debited from and credited to the account for the financial institution.

50. The computer-implemented method of claim 49, wherein the service fees charged to the financial institution for rendering services to the account holder of the at least one reward account are debited from the account for the financial institution.

51. The computer-implemented method of claim 49, wherein the first reward is a reward interest rate and the first reward amount is an interest income based on the “reward” interest rate.

52. The computer-implemented method of claim 14, wherein fees charged to the financial institution include an identification fraud protection fee.

53. A system for reconciling income in an account for a financial institution at an end of a statement cycle, the financial institution having reward accounts held by reward account holders, the computer system comprising:
at least one storage device for storing code data; and
at least one processor for processing the code data to:
determine whether at least one reward account at the financial institution meets, for a predetermined cycle, all qualification criteria for receiving a first reward;
calculate a first reward amount earned by the at least one reward account in response to determining that the at least one reward account meets all qualification criteria for receiving the first reward for the predetermined cycle;
determine whether the at least one reward account is entitled to receive income other than the first reward amount for the predetermined cycle;
add the calculated first reward amount and the income other than the first reward amount to a sum of earned income in response to determining that the at least one reward account is entitled to receive income other than the first reward amount during the predetermined cycle;
determine whether the account holder of the at least one reward account is enrolled to receive a at least one service for an at least one service fee from the financial institution during the predetermined cycle;
determine, in response to determining that the account holder of the at least one reward account is enrolled to receive the at least one service for an at least one service fee from the financial institution during the predetermined cycle, whether the at least one service fee is entitled to be automatically offset against income earned by the at least one reward account during the predetermined cycle;
debit the at least one service fee from the at least one reward account, in response to determining that the account holder of the at least one reward account is enrolled to receive the at least one service for the at least one service fee from the financial institution during the predetermined cycle;
credit the at least one service fee debited from the at least one reward account to the account for the financial institution;
determine whether the sum of earned income is greater than the at least one service fee;
automatically deduct the at least one service fee from the sum of earned income in response to determining that the sum of earned income is greater than the at least one service fee during the predetermined cycle;
automatically apply the sum of earned income toward the at least one service fee and apply a credit amount to the at least one reward account for any difference between the at least one service fee and the sum of earned income in response to determining that the sum of earned income is less than the at least one service fee;
debit the credit amount automatically applied to the at least one reward account from the account for the financial institution; and
issue an end of cycle statement to the financial institution, the end of cycle statement including all sums debited from and credited to the account for the financial institution.

54. The system of claim 54, wherein fees charged to the financial institution for rendering services to the account holder of the at least one reward account are debited from the account for the financial institution.

55. A computer program product on a computer-readable device for reconciling income in an account for a financial institution at an end of a statement cycle, the financial institution having reward accounts held by reward account holders, the computer program product comprising processor executable instructions for:
determining whether at least one reward account at the financial institution meets, for a predetermined cycle, all qualification criteria for receiving a reward;
calculating a reward amount earned by the at least one reward account in response to determining that the at least one reward account meets all qualification criteria for receiving the reward for the predetermined cycle;
determining whether the at least one reward account is entitled to receive income other than the reward amount for the predetermined cycle;
adding the calculated reward amount and the income other than the reward amount to a sum of earned income in response to determining that the at least one reward account is entitled to receive income other than the reward amount during the predetermined cycle;
determining whether the account holder of the at least one reward account is enrolled to receive a service for a service fee from the financial institution during the predetermined cycle;
determining, in response to determining that the account holder of the at least one reward account is enrolled to receive a service for a service fee from the financial institution during the predetermined cycle, whether the service fee is entitled to be automatically offset against income earned by the at least one reward account during the predetermined cycle;
debiting the service fee from the at least one reward account, in response to determining that the account holder of the at least one reward account is enrolled to receive a service for a service fee from the financial institution during the predetermined cycle;
crediting the service fee debited from the at least one reward account to the account for the financial institution;
determining whether the sum of earned income is greater than the service fee;
automatically deducting the service fee from the sum of earned income in response to determining that the sum of earned income is greater than the service fee during the predetermined cycle;
automatically applying the sum of earned income toward the service fee and applying a credit amount to the at least one reward account for any difference between the service fee and the sum of earned income in response to determining that the sum of earned income is less than the service fee;
debiting the credit amount automatically applied to the at least one reward account from the account for the financial institution; and
issuing an end of cycle statement to the financial institution, the end of cycle statement including all sums debited from and credited to the account for the financial institution.

56. The computer program product of claim 55, wherein fees charged to the financial institution for rendering services to the account holder of the at least one reward account are debited from the account for the financial institution.
